(19) United States
(12) Patent Application Publication
(10) Pub. No.: US 2018/0207806 A1
(43) Pub. Date: Jul. 26, 2018

(54) DEVICE FOR MOVING A WORKPIECE

(71) Applicant: Dr. Ing. h.c. F. Porsche Aktiengesellschaft, Stuttgart (DE)

(72) Inventors: Achim Henkel, Moeglingen (DE); Thorsten Weppert, Ludwigsburg-Poppenweiler (DE)

(21) Appl. No.: 15/860,711

(22) Filed: Jan. 3, 2018

(30) Foreign Application Priority Data
Jan. 24, 2017 (DE) 10 2017 101 290.7

(51) Int. Cl. B25J 15/00; B25J 11/00; B29C 37/00

(52) U.S. Cl. CPC B25J 15/00; B29C 37/0007; B25J 11/005

(57) ABSTRACT

A device (100) for moving a workpiece (103) has a gripping unit (102) and a drive unit (101). The gripping unit (102), in a first state, is coupled mechanically to the drive unit (101) and is designed to grip the workpiece (103). The drive unit (101) is designed to move the device (100). The gripping unit (102), in a second state, is uncoupled mechanically from the drive unit (101).

### CROSS REFERENCE TO RELATED APPLICATION

This application claims priority under 35 USC 119 to German Patent Appl. No. 10 2017 101 290.7 filed on Jan.24, 2017, the entire disclosure of which is incorporated herein by reference.

### BACKGROUND

### Field of the Invention

The invention relates to a device for moving a workpiece.

### Description of the Related Art

The prior art includes devices to remove a workpiece from another device, to position a workpiece in another device or to set down a workpiece on a set-down surface. The other device may be a tool that has been used to produce the workpiece or to process the workpiece.

The devices known from the prior art often are used for transporting a workpiece made of plastic. For example, the device can be used to remove the workpiece from the tool or the mold that has been used to produce the workpiece. The plastic may be a thermoplastic polymer, a thermosetting polymer, an elastomer and/or a thermoplastic elastomer or a combination thereof.

Known devices comprise a drive unit and a gripping unit. The drive unit is designed to move the device, whereas the gripping unit is designed to grip the workpiece. The gripping unit may comprise a gripping means that is moved by the gripping unit relative to the drive unit. For example, the gripping means may be arranged at the end of a gripping arm that is capable of being pivoted, extended, shortened and/or inclined.

The gripping unit is coupled mechanically to the drive unit. The drive unit supports the gripping unit. The relatively large distance between the gripping means and the drive unit results in undesirable vibration during the movement of the gripping means, in particular when the workpiece is gripped therein. This vibration constitutes a risk, since the workpiece could be damaged.

EP 1 063 072 A1 discloses a device with a vibration sensor, from which the measurement data are used to reduce the vibration of the gripping means.

AT 507 257 B1 discloses a device in which account is taken of elastic deformation of the components to reduce the vibration.

An object of the invention is to create a device that reduces the risk of damage to the workpiece. The intention also is to create a system having such a device and to provide a method of gripping a workpiece.

### SUMMARY

The device comprises a gripping unit and a drive unit. The gripping unit, in a first state, is coupled mechanically to the drive unit. Moreover, the gripping unit is designed to grip the workpiece, and the drive unit is designed to move the device. The gripping unit may comprise a gripping means and a gripping arm. The gripping arm may be coupled mechanically to the drive unit. The gripping means may be designed to grip the workpiece and to be arranged on the gripping arm. The gripping arm may be capable of being pivoted, inclined, extended and/or shortened, and therefore movement of the gripping arm can result in the gripping means being moved relative to the drive unit.

The gripping unit, in a second state, may be uncoupled mechanically from the drive unit, for example in an automated manner. In the uncoupled state, the gripping unit can be fastened and supported in a different way, so that vibration of the gripping means is reduced. For example, the gripping unit may be fastened closer to the workpiece that is to be gripped so that the distance between the fastening point and gripping means is smaller. The gripping unit can be coupled mechanically to the drive unit and moved after the workpiece has been gripped, and can be moved by the gripping arm into a region where the risk of damage is lower so that the device and the workpiece can be moved.

The gripping unit may be designed to grip the workpiece in the second state and also may be designed to grip the workpiece in the first state.

The gripping unit may comprise a fastening means and may be capable of being fastened on a further device by the fastening means.

The further device may be a tool for producing and/or processing the workpiece and/or may be a set-down device. For example, the further device may be a mold in which the workpiece has been molded and from which the workpiece is to be removed by the gripping unit. The set-down device may be a storage location for one or more workpieces. The device for processing the workpiece may be a mold in which the workpiece has a sheath or casing. Particularly precise positioning of the workpiece in the tool is particularly important. The device can position the workpiece precisely in the tool for processing the workpiece when the gripping unit is being fastened on the tool.

The operation of fastening the gripping unit on the tool for producing and/or for processing the workpiece is advantageous since the distance between the fastening point of the gripping unit and the workpiece is reduced. Hence, there is less vibration and the risk of damage to the workpiece is reduced. The gripping unit again can be coupled mechanically to the drive unit after the gripping unit removes the workpiece has been from the tool, since there is no longer a risk of the workpiece striking against the tool. A similar advantage is achieved when the gripping unit is fastened on the set-down device and the workpiece is to be set down on the set-down device or raised up therefrom. Positioning of the workpiece in the tool for processing the workpiece can be achieved particularly precisely by the device when the gripping unit has been fastened on the tool.

The fastening means may comprise an orienting element that is designed to orient the gripping unit relative to the further device when the gripping unit is being fastened on the further device. For example, it is possible for the further device to comprise a further orienting element. Thus, the two orienting elements are designed for form-fitting fastening of the gripping unit on the further device.

The further orienting element is a constituent part of the further device. The form-fitting connection is particularly advantageous since it is straightforward to establish and release. Moreover, orientation of the gripping unit relative to the further device can be achieved straightforwardly by the form-fitting connection.

The orientation of the gripping unit relative to the further device is advantageous for automated production processes since it achieves particularly good repeatability and precise positioning of the gripping unit and of the workpiece.

The orienting elements may be a pin and bore, cone and truncated cone or a sphere and shell.

The system may comprise a device according to the invention and also comprises the further device.

The further device may comprise the further orienting element that is designed for form-fitting connection to the orienting element of the device.

The invention also relates to a method that comprises fastening the gripping unit on the further device and then uncoupling the gripping unit from the drive unit. The gripping unit may have gripped the workpiece prior to these two steps. This may be the case, for example, when the workpiece is to be processed in the further device. As an alternative, it is also possible for the gripping unit to grip the workpiece only after the gripping unit has been uncoupled from the drive unit. This may be the case, for example, when the workpiece is to be removed from the further device.

The gripping unit can be fastened on the further device by the fastening means. The method may comprise orienting elements during the fastening operation to orient the gripping unit relative to the further device.

The method may further comprise moving the device in the direction of the workpiece before the gripping unit is fastened on the further device. This movement of the device can be triggered and/or executed, for example, by the drive unit. This provides for a relatively large movement capability of the device and also achieves a relatively low level of vibration of the workpiece in the vicinity of the further device.

The method can comprise moving the workpiece away from the further device once the workpiece has been gripped and then coupling the gripping unit to the drive unit. The method then comprises releasing the fastening of the gripping unit on the further device.

Further features and advantages of the invention will become clear from the following description with reference to the accompanying figure.

### BRIEF DESCRIPTION OF THE DRAWING

FIG. 1 is a schematic view of a device according to one embodiment of the invention with a workpiece gripped therein.

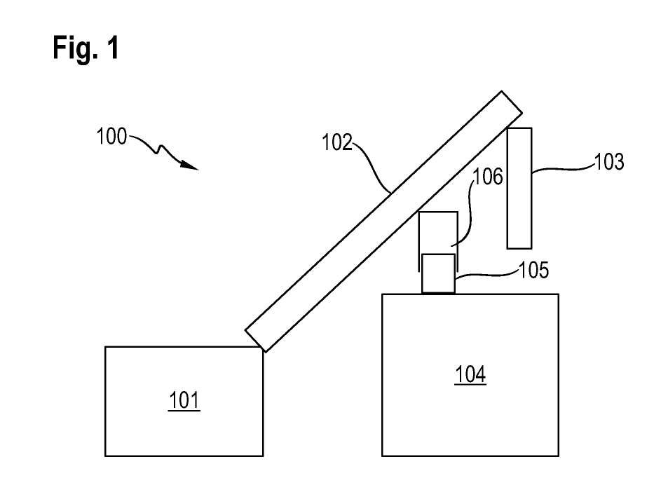

### DETAILED DESCRIPTION

The device 100 comprises a drive unit 101 and a gripping unit 102. The gripping unit 102 can be coupled to, and uncoupled from, the drive unit 101. The gripping unit is designed to grip a workpiece 103. For example it is possible for the gripping unit 102 to be coupled to the drive unit 101 when the workpiece 103 is to be transported over a relatively large distance with few obstructions in the vicinity of the workpiece 103.

The gripping unit 102 can be uncoupled from the drive unit 101 when movement of the workpiece 103 is to be precise as possible. Before the gripping unit 102 is uncoupled from the drive unit 101, it can be fastened on a further device 104 by a fastening means 106. For this purpose, the further device 104 also has a fastening means 105. The fastening means 106 and 105 may have orienting elements, by means of which the gripping unit 102 is oriented relative to the further device 104 when the gripping unit 102 is being fastened on the further device 104.

The further device may be, for example, a tool for producing the workpiece 103. In this case, the device 100 can be used to remove the workpiece 103 from the further device 104. The workpiece 103 is gripped by the gripping unit 102 only once the gripping unit 102 has been uncoupled from the drive unit 101 and fastened on the further device 104.

The operations of fastening the gripping unit 102 on the further device 104 and of uncoupling the gripping unit from the drive unit 101 have the advantage of the distance between the workpiece 103 and the gripping means of the gripping unit 102, said gripping means gripping the workpiece 103, being smaller, as a result of which the workpiece 103 is exposed to less pronounced vibration. This reduces the risk of damage to the workpiece 103 when it is being removed from the further device 104.

The further device 104 may also be a tool for processing the workpiece 103. In this case, the workpiece 103 has already been gripped beforehand by the gripping unit 102. The workpiece 103 is to be positioned as precisely as possible in the further device 104. This is done by the gripping unit 102 being fastened on the further device 104 and then being uncoupled from the drive unit 101. The operation of positioning the workpiece 103 can then take place in a particular precise manner, since the distance between the fastening means 106 and the workpiece 103 is smaller than the distance between the drive unit 101 and the workpiece 103. Removal of the workpiece 103 from the tool for processing the workpiece 103 can take place in a manner similar to the way in which the workpiece 103 can be removed from the production tool.

The further device 104 may also comprise a set-down surface, on which the workpiece 103 is to be set down. In this case, the workpiece 103 can be set down on the set-down surface in a manner similar to the way in which it can be positioned in the tool for processing the workpiece 103. If the workpiece 103 is to be raised up from the set-down surface, this can take place in a manner similar to the way in which the workpiece 103 can be removed from the tool for producing the workpiece 103.

What is claimed is:

1. A device 100 for moving a workpiece 103, comprising: a gripping unit 102 and a drive unit 101, the gripping unit 102, in a first state, is coupled mechanically to the drive unit 101, and the gripping unit 102 is designed to grip the workpiece 103, and the drive unit 101 is designed to move the device 100, wherein the gripping unit 102, in a second state, is uncoupled mechanically from the drive unit 101.

2. The device 100 of claim 1, wherein the gripping unit 102 is designed to grip the workpiece 103 in the second state.

3. The device 100 of claim 1, wherein the gripping unit 102 comprises a fastening means 106, and the gripping unit 102, in the second state, can be fastened on a further device 104 by the fastening means 106.

4. The device 100 of claim 1, wherein the further device 104 is a tool for producing and/or processing the workpiece 103 and/or in the form of a set-down device.

5. The device 100 of claim 1, wherein the fastening means 106 comprises an orienting element that is designed to orient the gripping unit 102 relative to the further device 104 when the gripping unit 102 is being fastened on the further device 104.

6. A system comprising the device 100 of claim 3 and also comprising the further device 104.

7. The system of claim 6, wherein the further device 104 comprises a further orienting element that is configured for form-fitting connection to the orienting element of the device 100.

8. A method of gripping a workpiece 103 using the device 100 of claim 3, wherein the method comprises the following steps:
fastening a gripping unit 102 on a further device 104; and then
uncoupling the gripping unit 102 from the drive unit 101; and
gripping the workpiece 103 using the gripping unit 102.

9. The method of claim 8, further comprising moving the device 100 toward the workpiece 103 before the gripping unit 102 is fastened on the further device 104.

10. The method of claim 8, further comprising:
moving the workpiece 103 away from the further device 104 once the workpiece 103 has been gripped;
coupling the gripping unit 102 to the drive unit 101;
releasing the fastening of the gripping unit 102 on the further device 104.
